(19) United States
(12) Patent Application Publication
(10) Pub. No.: US 2024/0255027 A1
(43) Pub. Date: Aug. 1, 2024

(54) A METHOD FOR MANUFACTURING A ROLLING OR PLAIN BEARING RING

(71) Applicant: AKTIEBOLAGET SKF, GOTEBORG (SE)

(72) Inventors: Marcus C. ANDERSSON, Molndal (SE); Marcel ESCURSELL, Göteborg (SE); Karl Åke Staffan LARSSON, Göteborg (SE)

(21) Appl. No.: 18/559,816

(22) PCT Filed: May 30, 2022
(86) PCT No.: PCT/EP2022/064628

§ 371 Date: Nov. 9, 2023

(30) Foreign Application Priority Data
Jun. 2, 2021 (DE) 102021205643.1

(51) Int. Cl. F16C 33/12; B22F 10/25; F16C 33/14

(52) U.S. Cl. CPC F16C 33/125; B22F 10/25; F16C 33/121; F16C 33/14; F16C 2204/64; F16C 2223/46

(57) ABSTRACT

A method for manufacturing a rolling or plain bearing ring includes providing a metallic ring member and applying a load carrying surface onto the metallic ring member by use of a steel wire Directed Energy Deposition (DED) operation and/or a steel metal powder DED operation. Preferably, the steel wire and/or the steel metal powder includes 0.10-0.50 wt % of carbon and 0.50-1.20 wt % of boron.

### TECHNICAL FIELD

The present invention concerns a method for manufacturing a rolling or plain bearing ring. The present invention also concerns a rolling or plain bearing ring and a rolling or plain bearing.

### BACKGROUND OF THE INVENTION

Rolling bearings and plain bearings are well-known mechanical components used for carrying loads while allowing a relative rotation between their bearing rings. The rolling bearing is carrying loads via rolling elements, such as balls and rollers, while the plain bearing, also referred to as a sliding bearing, is carrying loads via sliding surfaces.

A bearing ring is generally manufactured from a piece of rolled/forged steel substrate by e.g. surface cutting, grinding and honing until a final bearing ring component is provided. The bearing ring is also commonly subjected to a heat treatment process in order to increase its surface hardness and thereby achieve a high fatigue resistance of especially the ring's load carrying surfaces. Thereby a long service life can be achieved.

It is also known to e.g. provide bearing rings which are made of more expensive materials for providing increased performance. For example, a bearing ring may be made of stainless steel, thereby providing a corrosion resistant ring. Due to the relatively high cost of stainless steel, larger bearings—such as bearings having an outer diameter of more than 500 mm (millimeter)—may be very expensive to produce due to the high material cost or not even possible to produce due to limitation in reduction ratio.

Furthermore, it is also known to remanufacture used bearing rings. This is commonly done by removing damaged raceway surfaces from the bearing ring by a machining operation, e.g. by grinding. Thus, in order to not significantly change the dimension of the raceway surface, only a small part of the radius can be removed. For example, it is known to not remove more than 0.025 mm of material, as seen in the radial direction of the bearing ring. Therefore, this limitation results in that many bearing rings are not suitable for remanufacturing.

### SUMMARY OF THE INVENTION

In view of the above, an object of the invention is to provide an improved method for manufacturing a rolling or plain bearing ring which to at least to some extent overcomes some of the issues of the prior art. A further object of the invention is to provide an improved rolling or plain bearing ring. A yet further object is to provide an improved rolling or plain bearing.

At least one of these objects is achieved by a method comprising the steps recited in claim 1. Thus, a method for manufacturing a rolling or plain bearing ring is provided. The method comprises:
providing a metallic ring member; and
applying a load carrying surface onto the metallic ring member by use of a steel wire Directed Energy Deposition (DED) operation and/or a steel metal powder DED operation.

By the provision of the method as disclosed herein, an improved rolling or plain bearing ring is provided, in which at least one of its load carrying surfaces has been applied by a DED operation, such as a laser cladding operation. In particular, it has been realized that by a wire and/or powder based DED operation, an improved steel surface can be applied on the metallic ring member, wherein the steel surface is preferably a high performing steel surface. Thereby, a rolling or plain bearing ring with an increased service life is achieved in a cost-effective manner. Furthermore, by using DED, a thicker layer of the steel material can be applied on the metallic ring member, implying further improved performance and also increased possibility of remanufacturing more types of bearing rings. The present invention also provides increased flexibility since it enables to tailor the material of the load carrying surfaces for specific demanding applications, such as for pulp and paper applications, wind turbines, metal and mining industry applications, etc.

A load carrying surface is herein meant a surface which is intended to be subjected to loads, typically alternating loads, during use. Preferably, the load carrying surface is a raceway surface of the rolling or plain bearing ring. However, the load carrying surface may also e.g. be an inner circumferential surface of an inner bearing ring and/or an outer circumferential surface of an outer bearing ring. Still further, the load carrying surface may be any surface of the rolling or plain bearing ring which is intended to carry a load with a main force component which is directed substantially straight towards the surface.

DED, such as laser cladding, as used herein means a surface welding operation which enables a metallurgical bonding of the steel wire material and/or steel metal powder to the metallic ring member, thereby providing a DED bonded surface on the metallic ring member. Other examples of DED, except laser cladding, are plasma transferred arc (PTA), electron beam melting (EBM) and selected laser melting (SLM).

Optionally, the steel wire and/or steel metal powder preferably comprises Carbon (C) and Boron (B) as hardening mechanisms. It has namely been realized that DED, e.g. laser cladding, of a steel wire and/or steel metal powder which only comprises C as hardening mechanism may not provide a surface with a sufficient surface hardness without a high risk of cracking. In particular, it has been found that a raceway surface which has been coated with a steel wire and/or steel metal powder which only comprises C as hardening mechanism may not provide sufficient surface hardness, especially for more demanding applications, without a high risk of cracking in the raceway surface. Thereby, by also providing B as hardening mechanism it has been realized that a high surface hardness of the load carrying surface can be achieved which is suitable for more demanding applications, while also reducing the risk of cracking. For example, it has been found that a load carrying surface with a surface hardness of at least 55 HRC can be achieved, such as 55-58 HRC, when the steel metal powder and/or steel wire comprises C and B as hardening mechanisms.

Still optionally, the steel wire and/or steel metal powder may comprise 0.10-0.50 wt (weight) % of C and 0.50-1.20 wt % of B. For example, it has been found that a higher surface hardness can be achieved by using the aforementioned amounts of C and B, typically by using a higher amount of B compared to the amount of C in e.g. the steel metal powder. According to an example embodiment, the total wt % of C and B is in the range of 0.6-1.7 wt %, such as substantially 0.2 wt % C and 0.9 wt % B.

Optionally, the steel wire and/or steel metal powder may be a stainless steel wire and/or a stainless steel metal powder, respectively. Thereby, a corrosion resistant surface can be provided by the DED operation, implying a high-performance surface compared to e.g. the base material of the rolling or plain bearing ring. For example, a less expensive material may be used for the metallic ring member, such as a standard steel which is not stainless, e.g. a steel having a chromium (Cr) content below 10 wt %.

Preferably, the metallic ring member is a steel ring member.

Optionally, applying the load carrying surface may comprise applying more than one layer by use of laser cladding, such as 2-20 layers. Providing more than one layer, such as 2-layers, has shown to result in a high-performance surface with a satisfactory thickness for more demanding applications. This may also reduce the amount of heat transferred to the metallic ring member, implying a reduced risk of cracking in the metallic ring member.

Optionally, the application speed may be varied during application of the steel wire material and/or steel metal powder on the metallic ring member. Thereby, one or more layers with different radial thickness may be applied onto the metallic ring member. For example, the metallic ring member may be rotated with respect to a rotational axis of the metallic ring member while applying the load carrying surface, wherein the rotational speed is varied during application of the steel wire and/or steel metal powder on the metallic ring member. By varying the speed, less heat may be transferred to the metallic ring member during the DED operation. According to an example embodiment, the speed is varied by decreasing the speed at least one time during the application of the load carrying surface. Thereby a relatively high speed can be used when e.g. applying a first layer directly onto the metallic ring member, whereby a relatively low speed can be used when applying one or more additional layers on the first layer. Consequently, the first layer will be thinner than the one or more additional layers. This will result in that less heat will be transferred to the metallic ring member, thereby reducing the risk of generating cracks therein during the DED, e.g. the laser cladding, operation.

Still further, by varying the application speed, a surface with a varying radius may be provided with a load carrying surface with a substantially uniform thickness. For example, the rolling or plain bearing ring may have a spherical surface with a varying radius, whereby the application speed is varied such that a load carrying surface with a substantially uniform thickness is provided thereon. Accordingly, the application speed may be varied such that a constant surface speed is achieved during the DED operation.

Optionally, the final thickness of the applied load carrying surface may be 0.25-10 mm, as seen in a radial direction of the rolling or plain bearing ring.

Optionally, the method may further comprise:
prior to applying the load carrying surface, removing an old load carrying surface of the metallic ring member, such as removing 0.25-10 mm of material from the metallic ring member, as seen in a radial direction of the metallic ring member.

Accordingly, the method may be a method for remanufacturing an already used rolling or plain bearing ring. As such, by first removing an old load carrying surface, preferably an old raceway surface, a new high-performance layer can be applied on the metallic ring member by applying a new load carrying surface thereon by use of a DED operation according to the invention. Preferably, the new applied load carrying surface has a thickness which is equal to, or at least substantially equal to, the thickness of the material removed from the metallic ring member. Substantially equal to does herein mean that it is in the range of 100-150% of the original thickness, such as 100-130% or 100-110% of the original thickness depending on surface roughness after deposition. Thereby, the original dimension of the ring may be retained.

Optionally, the speed when applying the load carrying surface by DED, i.e. the DED speed, such as laser cladding speed, may be in the range of 0.5 to 1000 m (meter) per minute. According to an example embodiment, the DED speed is higher than 1 m per minute, such as higher than 20 m per minute, e.g. 80-120 m/minute, implying a reduced cracking risk of the metallic ring member. It has namely been found that a higher DED speed, such as laser cladding speed, may reduce the risk of cracking. Thereby, by e.g. using a higher laser cladding speed an improved rolling or plain bearing ring may be provided.

Optionally, when the DED operation is laser cladding, the laser power used when applying the load carrying surface may be 1-15 kW (kilowatts), such as 2-6 kW.

Optionally, the metallic ring member may be a case hardened or through hardened ring. According to an example embodiment, the method may further comprise, prior to applying the load carrying surface, subjecting the hardened ring to a machining operation for removing any distortion issues on the surface where the DED load carrying surface is intended to be provided. Thereby an improved bonding interface between the DED applied load carrying surface and the metallic ring member can be achieved.

The present invention also relates to a rolling or plain bearing ring for a rolling or plain bearing, wherein the rolling or plain bearing ring has been manufactured by the method according to any one of the embodiments of the method.

The rolling bearing ring may be a ring of any kind of rolling bearing. For example, it may be a ball bearing or roller bearing, including but not limited to a spherical roller bearing, a tapered roller bearing, a toroidal roller bearing, a cylindrical roller bearing, a spherical ball bearing, a deep groove ball bearing and an angular contact ball bearing. The plain bearing ring may be a ring of any kind of plain bearing, such as a spherical plain bearing.

Accordingly, the present invention also relates to a rolling or plain bearing comprising at least one rolling or plain bearing ring according to the invention.

### BRIEF DESCRIPTION OF THE DRAWINGS

The present invention will hereinafter be further explained by means of non-limiting examples with reference to the appended schematic figures where;

FIG. 1 is a cross-sectional view of a rolling or plain bearing ring according to an example embodiment of the present invention;

FIG. 2 is a schematic side view of a rolling bearing according to the invention;

FIG. 3 is a cross-sectional view of a rolling or plain bearing ring according to an example embodiment of the present invention; and

FIG. 4 is a flowchart of a method according to an example embodiment of the present invention.

It should be noted that the drawings have not necessarily been drawn to scale and that the dimensions of certain features may have been exaggerated for the sake of clarity.

### DETAILED DESCRIPTION OF EMBODIMENTS

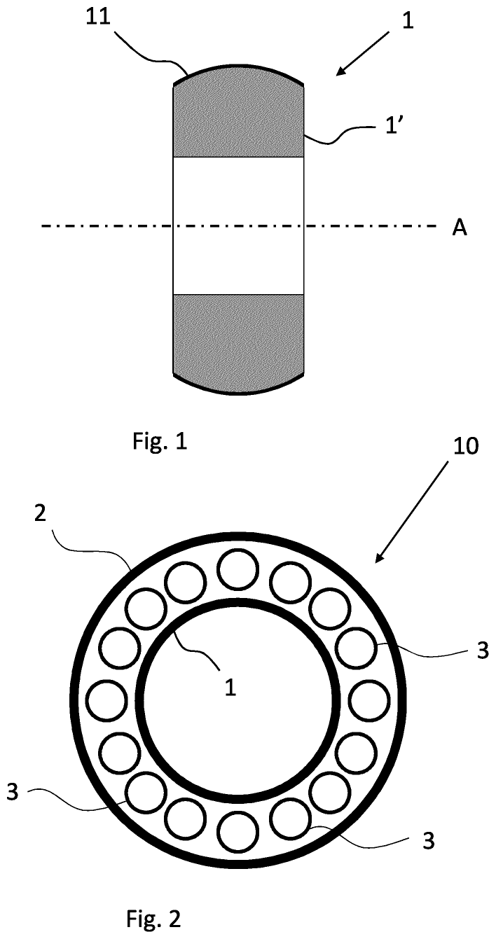

FIG. 1 depicts a cross-sectional view of a rolling or plain bearing ring 1 according to an example embodiment of the present invention. The cross-sectional view is defined by a plane which extends along a rotational axis A of the rolling or plain bearing ring 1. The rolling or plain bearing ring 1 comprises a metallic ring member 1′, which in the shown embodiment is a steel ring. It further comprises a load carrying surface 11 provided on the metallic ring member 1′. The load carrying surface 11 has been applied onto the metallic ring member 1′ by a DED operation according to an example embodiment of the method as disclosed herein.

The load carrying surface 11 is here a raceway surface, such as a raceway surface for rolling elements, i.e. balls and/or rollers. As shown, the raceway surface 11 may have a spherical shape. Thereby, the rolling or plain bearing ring 1 may be able to be misaligned relative an outer ring 2 (see FIG. 2). As such, a rolling or plain bearing 10, such as the rolling bearing shown in FIG. 2, which comprises the rolling or plain bearing ring 1, may be able to accommodate shaft deflections during use.

Accordingly, FIG. 2 depicts a side view of a rolling bearing 10 which comprises the rolling bearing ring 1 as e.g. shown in FIG. 1. The rolling bearing ring 1 is here an inner ring of the rolling bearing 10. The rolling bearing 10 further comprises the above-mentioned outer ring 2 and a plurality of rolling elements 3 which are provided in-between the outer ring 2 and the rolling bearing ring 1. It shall be understood that the outer ring 2 may alternatively or additionally be provided with a load carrying surface according to the invention.

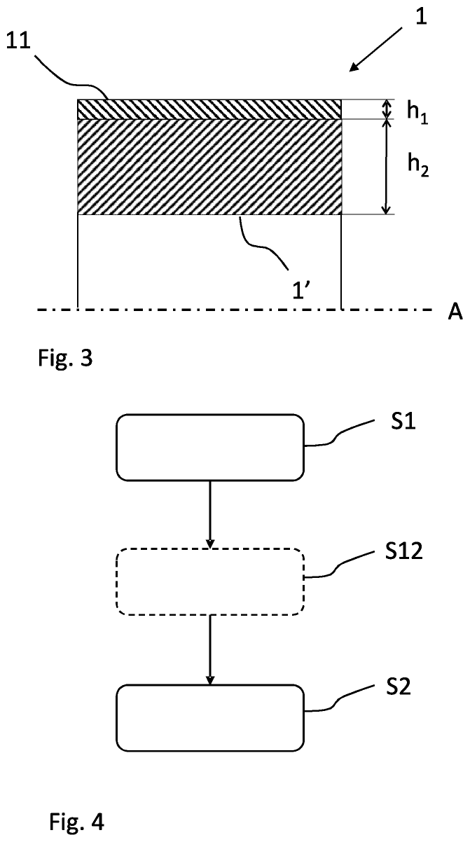

FIG. 3 depicts a cross-sectional view of a portion of a rolling or plain bearing ring 1 according to an embodiment of the invention. It comprises a load carrying surface 11 and a metallic ring member 1′, wherein the load carrying surface 11 has been applied by DED according to an example embodiment of the invention. The load carrying surface has a radial thickness h₁, which may be 0.25-10 mm. The radial direction of the ring 1 is perpendicular to and intersects the rotational axis A of the rolling or plain bearing ring 1. The metallic ring member 1′ has a radial thickness h₂ which is substantially larger than the radial thickness h₁, such as 10-500 mm.

In FIG. 4 a flowchart of a method according to an example embodiment of the invention is shown. The method is a method for manufacturing a rolling or plain bearing ring 1, such as the rings 1 shown in FIGS. 1-3.

The method comprises:
S1: providing a metallic ring member 1′; and
S2: applying a load carrying surface 11 onto the metallic ring member 1′ by use of a steel wire Directed Energy Deposition (DED) operation and/or a steel metal powder DED operation. For example, the DED operation may be a laser cladding operation.

The steel wire and/or steel metal powder which is applied onto the metallic ring member 1′ preferably comprises C and B as hardening mechanisms, thereby forming carbides and borides in the applied steel material. For example, as mentioned in the above, the steel wire and/or steel metal powder may comprise 0.10-0.50 wt % of C and 0.50-1.20 wt % of B, such as 0.15-0.30 wt % of C and 0.60-0.90 wt % of B. It has been found that a larger wt % of C may increase the risk of cracking in the load carrying surface 11. As such, by having a lower amount of C and a higher amount of B, a sufficient surface hardness can be achieved, such as more than 55 HRC, with a reduced risk of inducing cracks in the load carrying surface 11.

The steel wire and/or steel metal powder which is used for forming the load carrying surface 11 may be a stainless steel wire and/or stainless steel metal powder, respectively, thereby providing a corrosion resistant surface 11. For example, a corrosion resistant load carrying surface may thereby be provided on a large rolling or plain bearing ring 1 in a cost-effective manner.

Preferably, applying the load carrying surface 11 comprises applying more than one layer by use of DED, such as 2-20 layers.

Still further, the application speed may be varied during application of the steel wire material and/or steel metal powder on the metallic ring member 1′. For example, the speed may be varied by decreasing the speed at least one time during the application of the load carrying surface 11. Thereby, a thin layer may first be provided on the ring 1′, followed by one or more thicker layers when the application speed is reduced, until e.g. a final radial thickness h₁ of 0.25-10 mm is achieved.

The method may further comprise an optional step S12 (indicated by a box with a dashed line). The step S12 comprises:
prior to applying the load carrying surface 11, removing an old load carrying surface of the metallic ring member 1′, such as removing 0.25-10 mm of material from the metallic ring member 1′, as seen in a radial direction of the metallic ring member 1′. Accordingly, the present invention may be a method for remanufacturing an already used rolling or plain bearing ring 1.

The powder fraction of the steel metal powder may be 30-200 μm.

Furthermore, step S2 may be followed by a subsequent step of machining the applied load carrying surface 11, such as grinding and/or honing.

The load carrying surface 11 of the rolling or plain bearing ring 1 as shown in e.g. FIG. 1 has a varying radius, as seen in the cross-sectional view. In this embodiment, the radius is varying such that a spherical outer profile is formed. According to an example embodiment, the rotational speed of the metallic ring member 1′ during the DED step is varied such that a constant surface speed is achieved. Thereby a surface layer 11 with a uniform thickness can be obtained.

It is to be understood that the present invention is not limited to the embodiments described above and illustrated in the drawings; rather, the skilled person will recognize that many changes and modifications may be made within the scope of the appended claims.

1. A method for manufacturing a rolling or plain bearing ring, the method comprising the steps of:
providing a metallic ring member; and
applying a load carrying surface onto the metallic ring member by use of a steel wire Directed Energy Deposition (DED) operation and/or a steel metal powder DED operation, wherein the steel wire and/or the steel metal powder comprises 0.10-0.50 wt % of carbon and 0.50-1.20 wt % of boron.

2. The method according to claim 1, wherein the steel wire and/or steel metal powder comprises carbon and boron as hardening mechanisms.

3. (canceled)

4. The method according to claim 1, wherein the steel wire is a stainless steel wire and/or the steel metal powder is a stainless steel metal powder.

5. The method according to claim 1, wherein the step of applying the load carrying surface includes applying more than one layer by use of DED.

6. The method according to claim 1, wherein during the step of applying a load carrying surface, an application speed is varied during application of the steel wire material and/or the steel metal powder on the metallic ring member.

7. The method according to claim 6, wherein the application speed is varied by decreasing the speed at least one time during the step of applying the load carrying surface.

8. The method according to a claim 1, wherein a final radial thickness of the applied load carrying surface is 0.25 mm-10 mm.

9. The method according to claim 1, further comprising a step of:
prior to the step of applying the load carrying surface, removing an existing load carrying surface of the metallic ring member

10. A rolling or plain bearing ring for a rolling or plain bearing, wherein the rolling or plain bearing ring has been manufactured by the method according claim 1.

11. The method according to claim 5, wherein the step of applying the load carrying surface includes applying 2-20 layers by use of DED.

12. The method according to claim 9, wherein the step of removing an existing load carrying surface includes removing a radial thickness of a material of the metallic ring member, the radial thickness having a value of 0.25 mm-10 mm.
